(19) United States
(12) Patent Application Publication
(10) Pub. No.: US 2011/0252416 A1
(43) Pub. Date: Oct. 13, 2011

(54) NON-TRANSITORY COMPUTER READABLE MEDIUM, DEVICE DRIVER SETTING DEVICE, INSTALL DEVICE, DEVICE DRIVER PACKAGE, METHOD FOR SETTING DEVICE DRIVER AND INSTALL METHOD

(75) Inventor: Yasuo KOBAYASHI, Kanagawa (JP)

(73) Assignee: FUJI XEROX CO., LTD., Tokyo (JP)

(21) Appl. No.: 12/944,043

(22) Filed: Nov. 11, 2010

(30) Foreign Application Priority Data
Apr. 8, 2010 (JP) 2010-089357

(51) Int. Cl. G06F 9/445; G06F 17/30; G06F 3/048; G06F 3/12

(52) U.S. Cl. 717/174; 715/764; 707/793; 358/1.15; 707/E17.044

(57) ABSTRACT

A device driver setting device includes an acquiring unit, an allowing unit, and a writing unit. The acquiring unit acquires, from a data group constituting a device driver, condition information for each of one or more items which the device driver refers to. The condition information for each of the one or more items indicates a condition which can be taken by a setting value to be set in each of the items. The allowing unit allows a user to select a setting value which is to be set in each of at least a part of the items acquired, in accordance with the condition information associated with each of the at least a part of the items acquired. The writing unit writes setting values which are to be set in the respective items acquired into the data group based on a result of the selecting.

### CROSS-REFERENCE TO RELATED APPLICATIONS

This application is based on and claims priority under 35 USC 119 from Japanese Patent Application No. 2010-89357 filed Apr. 8, 2010.

### BACKGROUND

### Technical Field

Exemplary embodiments of the invention relate to a non-transitory computer readable medium storing a device driver setting program, a non-transitory computer readable medium storing an install program, a device driver setting device, an install device, a device driver package, a method for setting a device driver, and an install method.

### SUMMARY

According to an aspect of the invention, a non-transitory computer-readable medium stores a program that causes a computer to execute a device driver setting process. The process includes: acquiring, from a data group constituting a device driver, condition information for each of one or more items which the device driver refers to, wherein the condition information for each of the one or more items indicates a condition which can be taken by a setting value which is to be set in each of the one or more items; allowing a user to select a setting value which is to be set in each of at least a part of the one or more items acquired, in accordance with the condition information associated with each of the at least a part of the one or more items acquired; and writing setting values which are to be set in the respective items acquired into the data group based on a result of the selecting.

### BRIEF DESCRIPTION OF THE DRAWINGS

Exemplary embodiments of the invention will be described in detail based on the accompanying drawings, wherein:

FIG. 1 is an overall configuration view of an information processing system according to an exemplary embodiment of the invention;

FIG. 2 is an explanatory view showing contents of a process of creating a custom installer;

FIG. 3 is a view showing an example of setup item data;

FIG. 4 is a view showing an example of a setting value selection screen;

FIG. 5 is a view showing an example of the setting value selection screen where some of the setting values are changed;

FIG. 6 is a view showing an example of setting value change data;

FIG. 7 is an explanatory view showing contents of an install process;

FIG. 8 is a view showing an example of a setting value set;

FIG. 9 is a flowchart of a process of installing a printer driver according to a first example;

FIG. 10 is a flowchart of a process of installing the printer driver according to a second example;

FIG. 11 is a view showing an example of a setting value confirmation screen;

FIG. 12 is an explanatory view showing a process of creating a custom driver; and

FIG. 13 is an explanatory view showing a process of setting a driver.

### DETAILED DESCRIPTION

Exemplary embodiments of the invention will be described below with reference to the accompanying drawings.

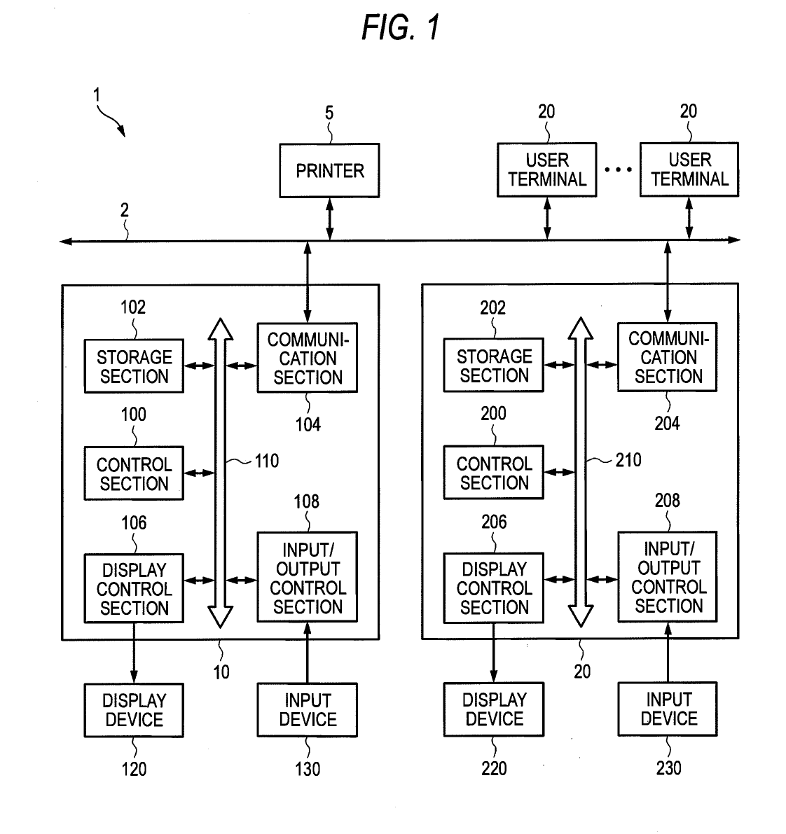

FIG. 1 shows an overall configuration view of an information processing system 1 according to a first exemplary embodiment. The information processing system 1 includes a printer 5, an administrator terminal 10, and one or more user terminals 20. The devices and terminals are connected so that they can perform data communications with each other through a network 2 such as a local area network.

The printer 5 is a network printer which receives print data (print job) transmitted from a computer (for example, the user terminal 20) and executes a print process based on the received print data.

The administrator terminal 10 is a computer having a function of creating a custom installer for installing a custom driver which has been refashioned in accordance with an environment of the information processing system 1 based on a device driver (printer driver) of the initial state (for example, factory default state). A process of creating the custom installer which is performed in the administrator terminal 10 will be described later in detail.

The administrator terminal 10 has a control section 100, a storage section 102, a communication section 104, a display control section 106, and an input/output control section 108 as the physical configuration. The respective sections are connected so that they can conduct data communications with each other through a bus 110.

The control section 100 may be implemented by a CPU (Central Processing Unit). The control section 100 executes a program stored in the storage section 102, which may be implemented by a semiconductor memory, a magnetic disk unit or the like, to thereby control the respective sections of the administrator terminal 10 and execute various processes. The storage section 102 stores programs executed by the control section 100 and data and is also used as a working memory of the control section 100. The programs stored in the storage section 102 include a custom installer creation program. The custom installer creation program may be supplied to the administrator terminal 10, which may be a computer, in a state where it is stored in an information storage medium or may be supplied through a data communication tool such as the Internet or an intranet. Examples of the information storage medium include a CD, a DVD and a USB memory.

The communication section 104 may be implemented by a network interface and conducts data communications with other devices (for example, the user terminal(s) 20, and the printer 5) connected through the network 2.

The display control section 106 may be implemented by a graphic interface and outputs graphic data to a display device 120, such as a liquid crystal display, connected through the graphic interface so as to display a UI (user interface) screen.

The input/output control section 108 may be implemented by a serial interface and accepts user's input from an input device 130, such as a keyboard and a mouse, connected through the serial interface.

The user terminal 20 may be a computer having a function of acquiring the custom installer created by the administrator terminal 10 and installing a printer driver based on the acquired custom installer. An install process based on the custom installer, which is executed in the user terminal 20, will be described later in detail.

The user terminal 20 includes a control section 200, a storage section 202, a communication section 204, a display control section 206, and an input/output control section 208 as the physical configuration. The respective sections are connected so that they can conduct data communications with each other through a bus 210.

The control section 200 may be implemented by a CPU (Central Processing Unit) and executes a program stored in the storage section 202 which may be implemented by a semiconductor memory or a magnetic disk unit, to thereby control the respective sections of the user terminal 20 and execute various processes. The storage section 202 stores programs executed by the control section 200 and data, and is also used as a working memory of the control section 200. The programs may be supplied to the user terminal 20, which may be a computer, in a state where the programs are stored on an information storage medium or may be supplied through a data communication tool such as the Internet or an intranet.

The communication section 204 may be implemented by a network interface and conducts data communications with other devices (for example, the administrator terminal 10 and the printer 5) connected through the network 2.

The display control section 206 may be implemented by a graphic interface and outputs graphic data to a display device 220, such as a liquid crystal display, connected through the graphic interface to display a screen.

The input/output control section 208 may be implemented by a serial interface, for example, and accepts user's input from an input device 230, such as a keyboard and a mouse, connected through the serial interface.

### [Processes Executed in Administrator Terminal 10]

The process of creating the custom installer which is executed in the administrator terminal 10 will be described below in detail.

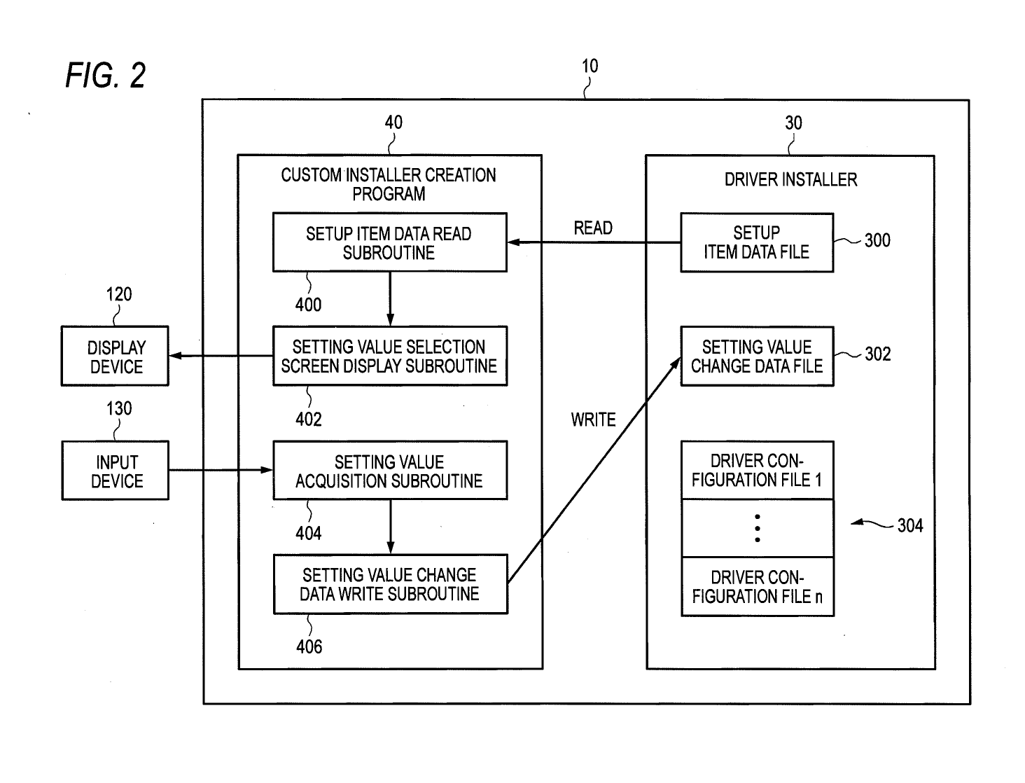

FIG. 2 is an explanatory view showing contents of a process of creating a custom installer in accordance with a custom installer creation program 40. A driver installer 30 shown in FIG. 2 includes a setup item data file 300, a setting value change data file 302, and a driver configuration file group 304. The driver installer 30 may further include a setup program for executing an install process.

The setup item data file 300 is a file storing setup items of the printer driver and data containing data value conditions stored in the setup items. For example, the setup items of the printer driver may correspond to all or some functions of a printer to be controlled by the printer driver. The data value conditions may designate a type of data which is set in each setup item, options of data and input ranges of data, etc.

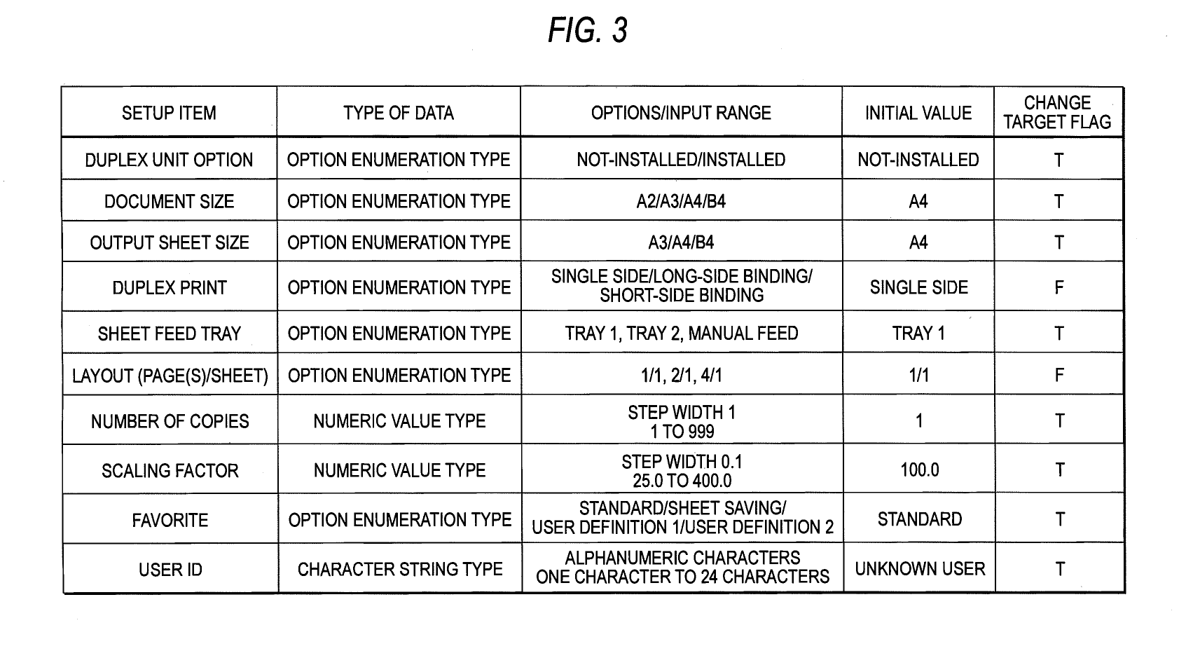

FIG. 3 shows an example of setup item data stored in the setup item data file 300. As shown in FIG. 3, the setup item data may include records each of which stores, in association of the setup item, a type of data to be set in the setup item, options/input range that data can take, an initial value which may be a factory default value, and a change target flag indicating as to whether or not data of the setup item is to be changed during creation of the custom installer. A true or false value may be stored in the change target flag. If the change target value of a certain setup item is true (T), data of the certain setup item is set to a target to be changed, and if it is false (F), the data of the certain setup item are excluded from targets to be changed.

Of the setup items stored in the setup item data, the setting value change data file 302 stores a setup item(s) whose a setting value(s) have been changed and the changed setting value(s). It is assumed that the setting value change data file 302 of the driver installer 30 in the factory default state does not store any data.

The driver configuration file group 304 includes one or more driver configuration files constituting the printer driver, such as a UI module for enabling to change the setting values of the printer driver using a UI screen and a rendering module for processing print data.

In the administrator terminal 10, the control section 100 processes the driver installer 30 in accordance with the custom installer creation program 40 to create the custom installer. As shown in FIG. 2, the custom installer creation program 40 includes, for example, a setup item data read subroutine 400, a setting value selection screen display subroutine 402, a setting value acquisition subroutine 404, and a setting value change data write subroutine 406.

The control section 100 refers to the setup item data file 300 of the driver installer 30 in accordance with the setup item data read subroutine 400 and reads the setup item data stored in the setup item data file 300 into the storage section 102.

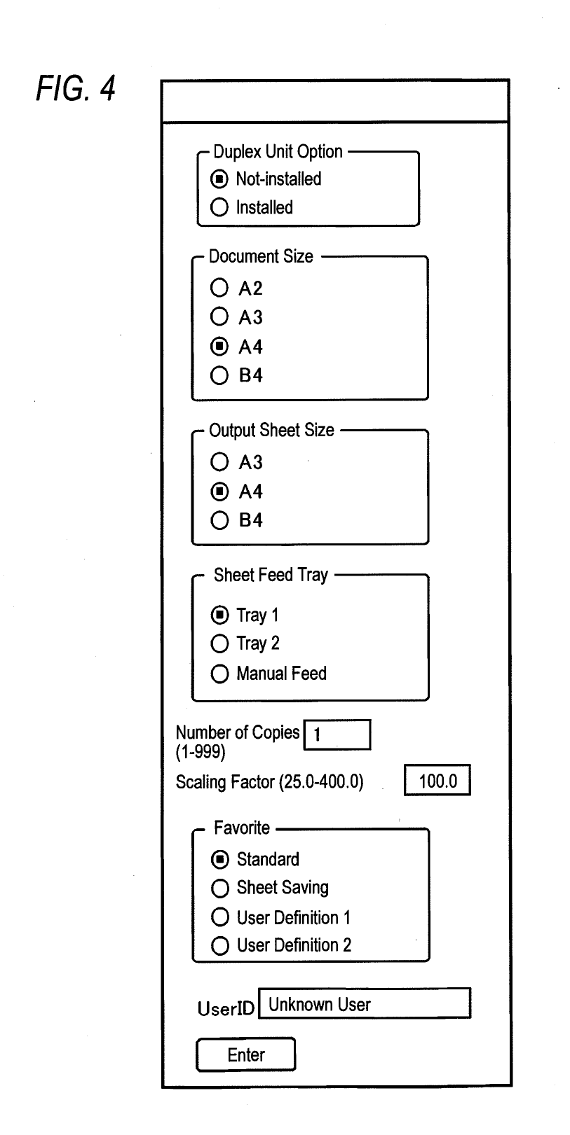

Next, the control section 100 generates setting value selection screen data based on the setup item data read into the storage section 102 in accordance with the setting value selection screen display subroutine 402. Then, the control section 100 displays a setting value selection screen (see FIG. 4) on the display device 120 by the display control section 106 based on the generated setting value selection screen data. Specifically, the control section 100 extracts a record(s) in which the change target flag is true (T) from the setup item data and generates the setting value selection screen data based on the setup item(s), the type(s) of data, the value(s) that the data can take, and the initial value(s) which are contained in the extracted record(s).

FIG. 4 shows an example of the setting value selection screen. In the example of the setting value selection screen shown in FIG. 4, a data entry field is formed for each setup item based on the type of data and the options/input range that data can take in the setup item. As an initial state, the initial value contained in each setup item data is selected and displayed in the formed data entry field.

In accordance with the setting value acquisition subroutine 404, the control section 100 acquires setting value data indicating setting values of the respective setup items which are selected by an administrator through the setting value selection screen. Then, the control section 100 stores the acquired setting value data in the storage section 102. Specifically, when the administrator sets desired values for the respective setup items which are displayed on the setting value selection screen using the input device 130 and presses an “enter” button, the control section 100 may detect the press event of the “enter” button and read the setting values, which are set in the respective setup items through the setting value selection screen, in conjunction with the detection.

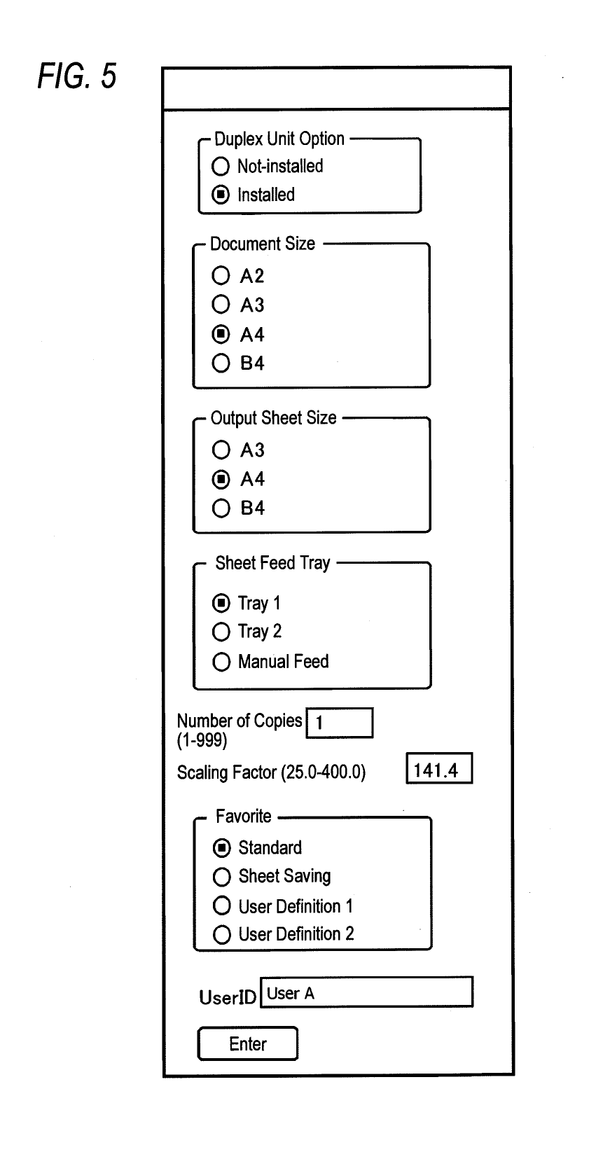

FIG. 5 shows an example of the setting value selection screen where the setting values is changed by the administrator's input. In the example shown in FIG. 5, the setting value of a setup item “duplex unit option” is changed from “not installed” to “installed,” the setting value of a setup item “scaling factor” is changed from “100.0” to “141.4,” and the setting value of a setup item “User ID” is changed from “Unknown User” to “User A.”

Next, in accordance with the setting value change data write subroutine 406, the control section 100 selects setup items whose setting values have been changed from the initial values, from among the setup items which are acquired in accordance with the setting value acquisition subroutine 404, and writes the selected setup items and information about the setting values of the selected setup items into the setting value change data file 302 contained in the driver installer 30.

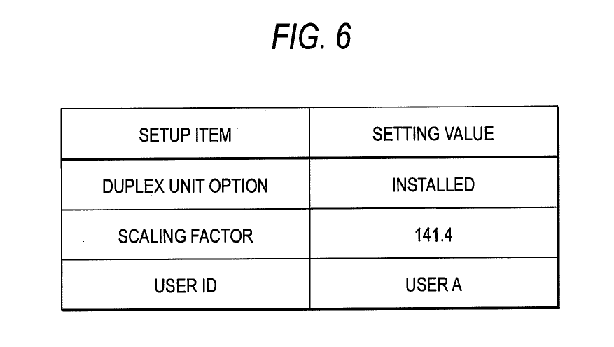

FIG. 6 shows an example of the setting value change data written into the setting value change data file 302. The example of the setting value change data shown in FIG. 6 is configured in such a manner that the changed setting values are stored in association with the setup items which are changed by the administrator.

With the above-described processes, the administrator terminal 10 updates the contents of the setting value change data file 302 contained in the driver installer 30 to create the custom installer, and transmits the created custom installer to each user terminal 20. The custom installer may be supplied to the user terminal 20 in a state where the custom installer is stored in an information storage medium.

### [Processes Executed in User Terminal 20]

Next, a process of installing the printer driver based on the custom installer received from the administrator terminal 10, which is executed in the user terminal 20 will be described in detail. In the user terminal 20, installing of the printer driver based on the custom installer may be executed in accordance with an install program of a device driver contained in an operating system. Alternatively, if a setup program is contained in the custom installer, the installing of the printer driver based on the custom installer may be executed in accordance with the setup program.

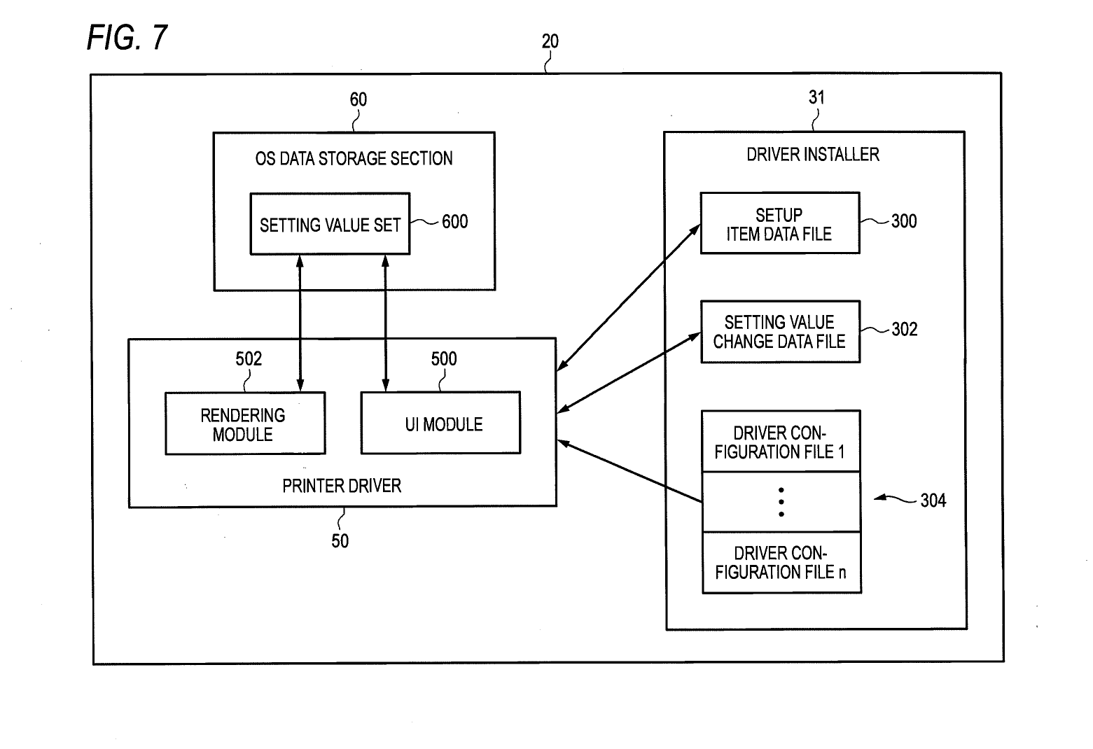

FIG. 7 is an explanatory view showing contents of an install process based on the custom installer 31 in the user terminal 20. As shown in FIG. 7, the control section 200 refers to the custom installer 31 to read the driver configuration file group 304 contained in the custom installer 31, expands the respective driver configuration files in a specified path, and sets up a program of the printer driver 50 containing a UI module 500 and a rendering module 502 to be in an executable state. Further, the control section 200 refers to the setup item data file 300 and the setting value change data file 302, which are contained in the custom installer 31, and stores setting values (setting value set 600), which are to be set in the setup items of the printer driver 50, in an OS data storage section 60 (for example, a registry) which stores control information of the operating system (OS). Specifically, the control section 200 may once set the initial values in the respective setup items based on the contents of the setup item data file 300, and thereafter may change the setting values of the setup items of which the setting value change data file 302 indicates that setting values have been changed. One method for storing data in the setting value set 600, other than the method described above, may overwrite the initial values of the setup items contained in the setup item data file 300 with the setting values stored in the setting value change data file 302 and then set values in the setting value set 600. It should be noted that the method for storing data in the setting value set 600 is not limited to the above examples.

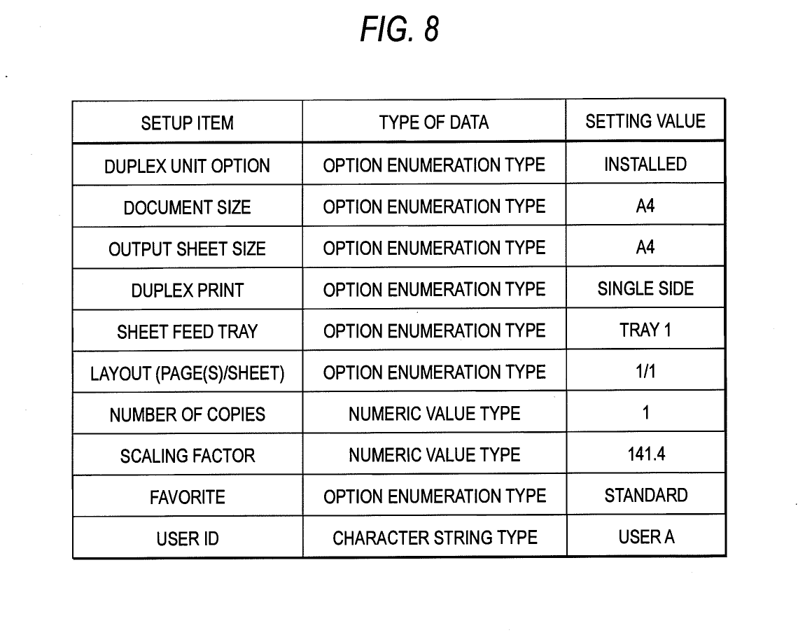

FIG. 8 shows an example of the setting value set 600, which is stored in the OS data storage section 60 based on the setup item data file 300 and the setting value change data file 302. As shown in FIG. 8, the data stored in the setting value change data file 302 are set in the “duplex unit option,” the “scaling factor,” and the “User ID” of the setting value set 600, and the data of the initial values stored in the setup item data file 300 are set in the other setup items of the setting value set 600.

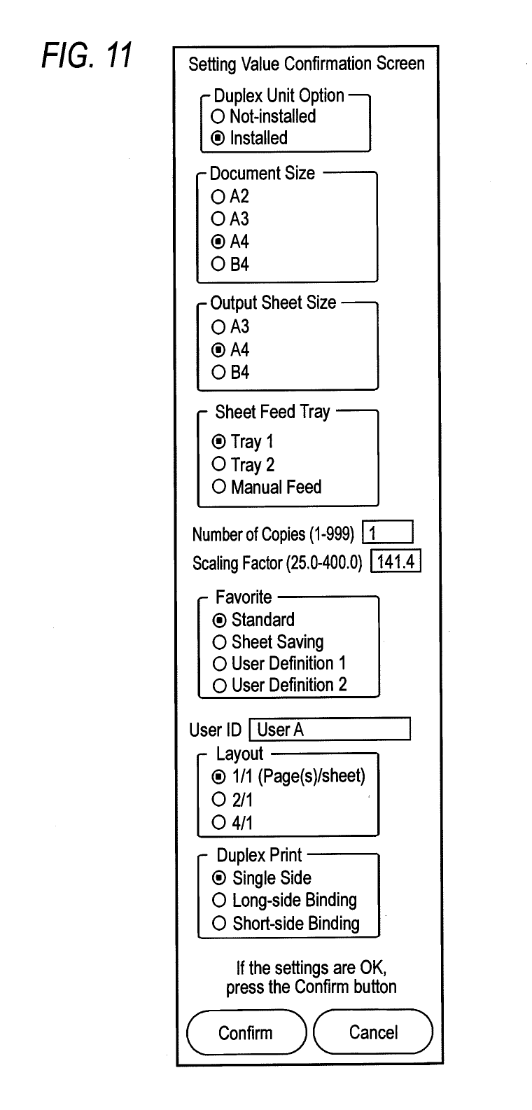

The UI module 500 has an API (Application Program Interface) for reading/writing the setting value set 600 stored in the OS data storage section 60. The UI module 500 has a function of displaying the setting values of the setup items stored in the setting value set 600 in a state where the user can select the setting value(s) (for example, see FIG. 11) and, upon accepting a command to change a value set in a setup item from the user, rewriting the data in the setting value set 600 in accordance with the accepted change command.

The rendering module 502 has an API for reading the setting value set 600 stored in the OS data storage section 60. In response to a print request accepted from the user, the rendering module 502 executes a rendering process based on the read setting value set 600 to generates print data (print job). The print data generated by the rendering module 502 is transmitted to the printer 5 through the communication section 204, and a print process is executed in the printer 5, which receives the print data.

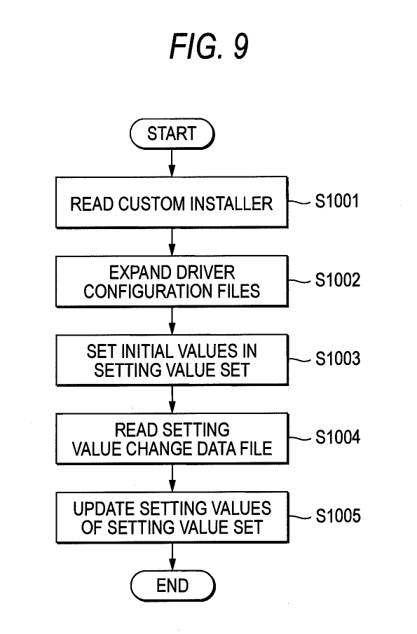

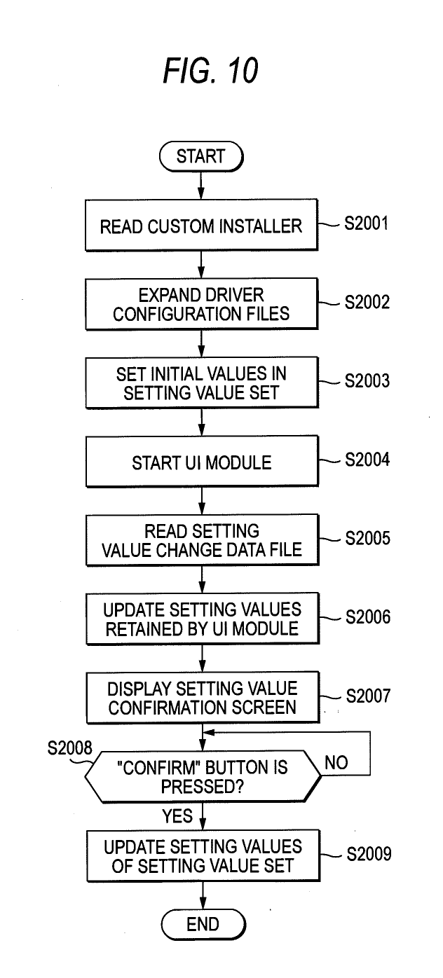

A flow of the process of installing the printer driver based on the custom installer in the user terminal 20 will be described with reference to flowcharts shown in FIGS. 9 and 10.

FIG. 9 is a flowchart of the process of installing the printer driver according to a first example. In the first example shown in FIG. 9, the user terminal 20 reads the custom installer (S1001), expands the driver configuration files contained in the read custom installer (S1002), and sets initial values in the setting value set 600 of the printer driver, which is stored in the OS data storage section 60, based on the setup item data file 300 contained in the custom installer (S1003). Then, the user terminal 20 reads the setting value change data file 302 contained in the custom installer (S1004), updates the setting values in the setting value set 600 of the printer driver, which is stored in the OS data storage section 60, based on the read setting value change data file 302 (S1005), and terminates the install process.

In the example, the steps S1004 and S1005 are executed following the step S1003. However, the steps S1004 and S1005 may be executed at any timing if they are executed before a print setting confirmation screen for a print request accepted from the user is displayed. For example, the steps S1004 and S1005 may be executed at a timing at which the UI module 500 is first started. Alternatively, the steps S1004 and S1005 may be executed at a timing at which a print request is accepted from the user.

FIG. 10 shows a flowchart of the process of installing the printer driver according to a second example. In the second example shown in FIG. 10, the user terminal 20 reads the custom installer (S201), expands the driver configuration files contained in the read custom installer (S202), and sets the initial values in the setting value set 600 of the printer driver, which is stored in the OS data storage section 60, based on the setup item data file 300 contained in the custom installer (S2003).

Next, the user terminal 20 starts the UI module 500 (S2004), the UI module 500 reads the setting value change data file 302 contained in the custom installer (S2005), the UI module 500 updates the setting values, which the UI module 500 retains, based on the contents of the read setting value change data file 302 (S2006), and displays a setting value confirmation screen based on the contents of the updated setting value set 600 (S2007).

FIG. 11 shows an example of the setting value confirmation screen. As shown in FIG. 11, the setting values of the respective setup items in the custom installer are displayed on the setting value confirmation screen. On the setting value confirmation screen, such a display manner may be used in which setup items having not been changed from the factory default state and setup items having been change can be distinguished from each other.

When the user terminal 20 detects the user pressing a “confirm” button contained in the setting value confirmation screen (Yes at S2008), the user terminal 20 updates the setting values of the setting value set 600 of the printer driver, which is stored in the OS data storage section 60, based on the settings displayed on the setting value confirmation screen (S2009) and terminates the install process.

The custom installer creation program according to the first exemplary embodiment described above need not be created individually for each of device drivers for different models and the like. Furthermore, during creating of the custom installer, the device driver needs not once be installed in the administrator terminal 10. In the custom installer, which is created by the technique according to the first exemplary embodiment, the settings of the custom installer are displayed before the device driver is actually installed, thereby making it possible to provide a flow in which a user confirms settings. Also, the custom installer creation program according to the first exemplary embodiment does not read the setting value set 600 (binary data) stored in the OS data storage section 60. Therefore, even if the contents of the OS data storage section 60 are changed due to OS version change or the like, the custom installer creation program is unaffected.

It should be noted that the invention is not limited to the first exemplary embodiment described above. For example, no setting value change data file 302 may be provided in the deriver installer. In this case, the initial values in the setup item data file 300 may be rewritten with values changed by the administrator. In the above first exemplary embodiment, described is the example in which the invention is applied to the device driver of the network printer. However, the invention is, of course, applied to creating custom installers of device drivers for various devices having no network function, such as a printer and a scanner.

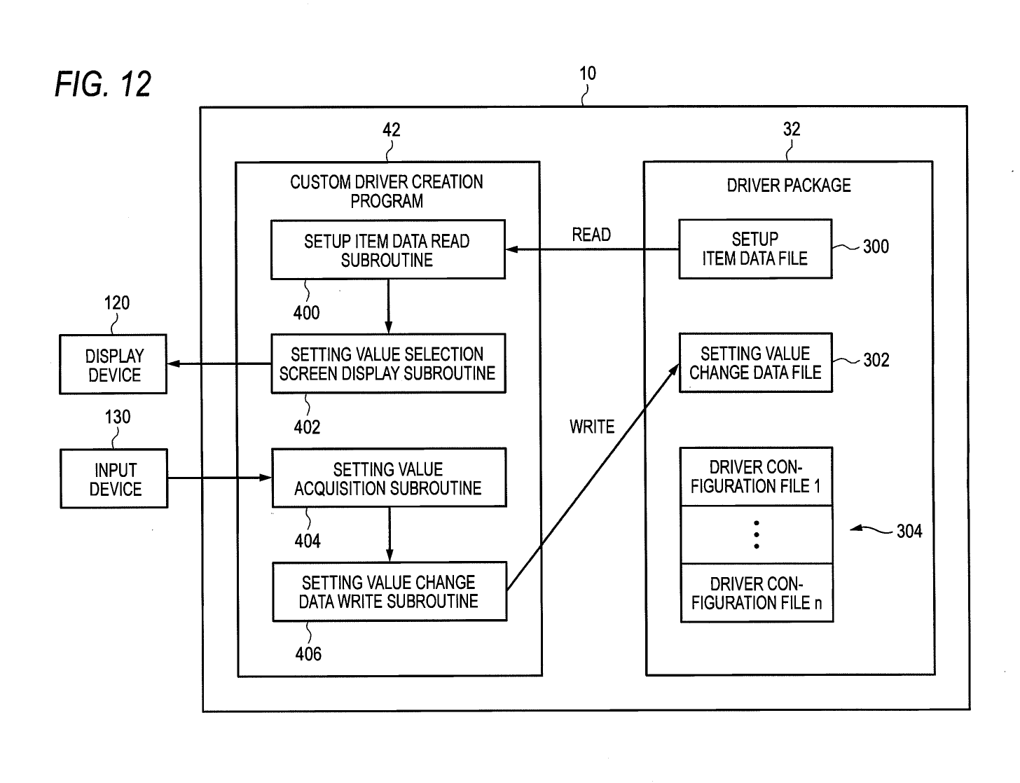

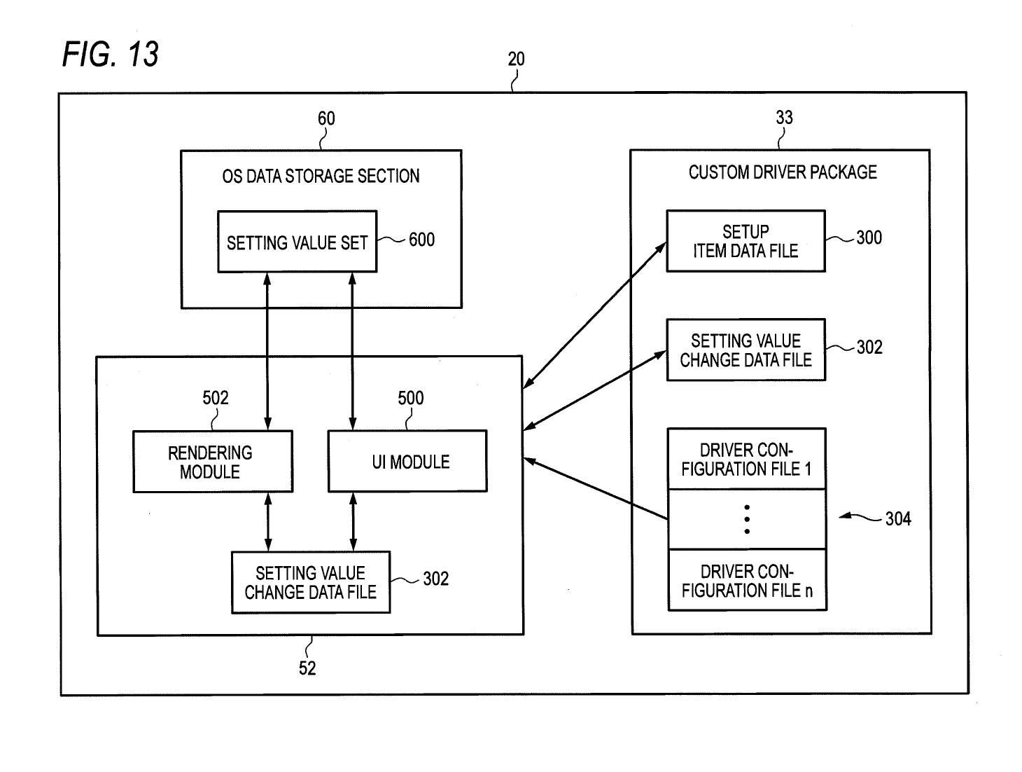

Next, a second exemplary embodiment of the invention will be described with reference to FIGS. 12 and 13. In the second exemplary embodiment, it is assumed that an administrator terminal 10 customizes a driver package, and that a user terminal 20 installs the customized driver package (custom driver package) without using a dedicated installer which is created in order to install the driver package. The driver package is a data group constituting a device driver, and no installer (setup program) may be contained in the driver package.

FIG. 12 is an explanatory view showing a process of creating the custom driver package. As shown in FIG. 12, a driver package 32 includes a setup item data file 300, a setting value change data file 302, and a driver configuration file group 304. A custom driver creation program 42 includes a setup item data read subroutine 400, a setting value selection screen display subroutine 402, a setting value acquisition subroutine 404, and a setting value change data write subroutine 406. A process of writing information into the setting value change data file 302 of the driver package 32 which is executed based on the custom driver creation program 42 is common to that of the first embodiment, and therefore will not be described again.

FIG. 13 is an explanatory view showing a process of setting a driver based on the customized driver package (custom driver package 33). The user terminal 20 reads the custom driver package 33 to install a UI module 500, a rendering module 502, and the setting value change data file 302 as one of configuration files of a printer driver 52. When the printer driver 52 is installed, setting values of respective setup items are stored in a setting value set 600 based on the initial values of the respective setup items, which are set in the setup item data file 300, and default values of the respective setup items, which are set in an operating system.

In the second exemplary embodiment, it is assumed that the printer driver 52 refers to the setting value change data file 302 at a first timing, a second timing, and a third timing (which will be described later) after the printer driver 52 is installed, to rewrite the setting values of the respective setup items, which are stored in the setting value set 600. Specific examples of the first to third timings will be described below.

The first timing is a time when the printer driver 52 is first loaded from the operating system after the printer driver 52 is installed. After the printer driver 52 is loaded from the operating system, either the UI module 500 or the rendering module 502 may refer to the setting value change data file 302 to rewrite the setting values of the setup items, which are stored in the setting value set 600, based on the setting values of the setup items, which are stored in the setting value change data file 302.

The second timing is a time when the UI module 500 first displays a UI screen after the printer driver 52 is installed. At the second timing, the UI module 500 may refer to the setting value change data file 302 to rewrite the setting values of the setup items, which are stored in the setting value set 600, based on the setting values of the setup items, which are stored in the setting value change data file 302.

The third timing is a time when printing is first performed after the printer driver 52 is installed. At the third timing, the rendering module 502 may refer to the setting value change data file 302 to rewrite the setting values of the setup items, which are stored in the setting value set 600, based on the setting values of the respective setup items, which are stored in the setting value change data file 302.

If the setting values of the setup items, which are stored in the setting value set 600, are rewritten with the stored contents of the setting value change data file 302 being referred to, the setting values may not be rewritten at the second timing or at the third timing. If the setting values are not rewritten at the first timing, the setting values may be rewritten at the second or third timing.

With the custom driver creation program 42 and the custom driver package 33 according to the second exemplary embodiment described above, even if an install program dedicated to the custom driver package 33 is not provided on the operation system side, the changed contents of the setting values which are written into the custom driver package 33 are reflected to the setting value set 600 retained in the operation system side at a point in time where the printer driver 52 is used. In the description of the exemplary embodiment, the invention is applied to the device driver for the network printer, by way of example. However, the invention can, of course, be applied to creating of custom installers of device drivers for various devices having no network function such as a printer and a scanner.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A non-transitory computer-readable medium storing a program that causes a computer to execute a device driver setting process, the process comprising:
acquiring, from a data group constituting a device driver, condition information for each of one or more items which the device driver refers to, wherein the condition information for each of the one or more items indicates a condition which can be taken by a setting value which is to be set in each of the one or more items;
allowing a user to select a setting value which is to be set in each of at least a part of the one or more items acquired, in accordance with the condition information associated with each of the at least a part of the one or more items acquired; and
writing setting values which are to be set in the respective items acquired into the data group based on a result of the selecting.

2. The non-transitory computer readable medium according to claim 1, wherein
a predetermined initial value for each of the one or more items is stored in the data group in association with each of the one or more items, and
the writing writes a setting value which is changed from the initial value associated with each of the one or more items acquired, into the data group based on a result of the selecting.

3. The non-transitory computer readable medium according to claim 1, wherein
the data group stores, for each of the one or more items, information indicating as to whether or not the setting value is to be changed, in association with each of the one or more items, and
of the one or more items, the allowing allows the user to select a setting value which is to be set in an item associated with information indicating that the setting value is to be changed, in accordance with the condition information associated with each item.

4. The non-transitory computer readable medium according to claim 2, wherein
the data group stores, for each of the one or more items, information indicating as to whether or not the setting value is to be changed, in association with each of the one or more items, and
of the one or more items, the allowing allows the user to select a setting value which is to be set in an item associated with information indicating that the setting value is to be changed, in accordance with the condition information associated with each item.

5. A non-transitory computer-readable medium storing an install program that causes a computer to execute an install process, the process comprising:
acquiring a data group including
a driver storage section that stores a program of a device driver,
an item information storage section that stores, for each of one or more items which the device driver refers to, condition information in association with each of the one or more items, wherein the condition information for each of the one or more items indicates a condition which can be taken by a setting value which is to be set in each of the one or more items, and
a setting value storage section that stores a setting values which are to be set in at least a part of the one or more items, based on a result of selecting the setting value, which is to be set in each of the at least a part of the one or more items, in accordance with the condition information associated with each of the at least a part of the one or more items;
creating the device driver based on the program stored in the driver storage section of the data group acquired;
of the one or more items, which the created device driver refers to, setting the setting values, which are stored in the setting value storage section, in the items whose setting values are stored in the setting value storage section; and
setting predetermined initial values in the other items.

6. The non-transitory computer readable medium according to claim 5, wherein the install process further comprises displaying the setting values in the one or more items which the device driver refers to, based on storage contents of the item information storage section and storage contents of the setting value storage section.

7. A device driver setting device comprising:
an acquiring unit that acquires, from a data group constituting a device driver, condition information for each of one or more items which the device driver refers to, wherein the condition information for each of the one or more items indicates a condition which can be taken by a setting value which is to be set in each of the one or more items;
an allowing unit that allows a user to select a setting value which is to be set in each of at least a part of the one or more items acquired, in accordance with the condition information associated with each of the at least a part of the one or more items acquired; and
a writing unit that writes setting values which are to be set in the respective items acquired into the data group based on a result of the selecting.

8. An install device comprising:
an acquiring unit that acquires a data group including
a driver storage section that stores a program of a device driver,
an item information storage section that stores, for each of one or more items which the device driver refers to, condition information in association with each of the one or more items, wherein the condition information for each of the one or more items indicates a condition which can be taken by a setting value which is to be set in each of the one or more items, and
a setting value storage section that stores a setting values which are to be set in at least a part of the one or more items, based on a result of selecting the setting value, which is to be set in each of the at least a part of the one or more items, in accordance with the condition information associated with each of the at least a part of the one or more items;
a creating unit that creates the device driver based on the program stored in the driver storage section of the data group acquired;
a setting unit, wherein
of the one or more items, which the created device driver refers to, the setting unit sets the setting values, which are stored in the setting value storage section, in the items whose setting values are stored in the setting value storage section, and
the setting unit sets predetermined initial values in the other items.

9. A non-transitory computer readable medium storing data for access by a program executed on a computer, comprising:
a data structure stored in the medium, the data structure including
a driver storage section that stores a program of a device driver,
an item information storage section that stores, for each of one or more items which the device driver refers to, condition information in association with each of the one or more items, wherein the condition information for each of the one or more items indicates a condition which can be taken by a setting value which is to be set in each of the one or more items, and
a setting value storage section that stores a setting values which are to be set in at least a part of the one or more items, based on a result of selecting the setting value, which is to be set in each of the at least a part of the one or more items, in accordance with the condition information associated with each of the at least a part of the one or more items.
